(19) United States
(12) Patent Application Publication
(10) Pub. No.: US 2025/0101181 A1
(43) Pub. Date: Mar. 27, 2025

(54) RESIN COMPOSITION AND PRODUCTION METHOD THEREFOR, AND CURED PRODUCT OF RESIN COMPOSITION

(71) Applicant: Resonac Corporation, Tokyo (JP)

(72) Inventors: Kitaru SATO, Tokyo (JP); Souichirou KOMIYA, Tokyo (JP)

(21) Appl. No.: 18/859,077

(22) PCT Filed: Oct. 3, 2023
(86) PCT No.: PCT/JP2023/036107

§ 371 Date: Oct. 22, 2024

(30) Foreign Application Priority Data
Oct. 5, 2022 (JP) 2022-161072

(51) Int. Cl. C08G 73/10; C08F 299/02

(52) U.S. Cl. CPC C08G 73/1032; C08F 299/022; C08G 73/1021

(57) ABSTRACT

A method for producing a resin composition is disclosed. The method for producing a resin composition includes: obtaining a polyimide resin by reacting a tetracarboxylic dianhydride with a polyamine in an organic solvent; and obtaining a resin composition containing a polymaleimide resin and the organic solvent by reacting the polyimide resin with maleic anhydride. The polyamine contains dimer diamine. The organic solvent contains 1,2,4-trimethylbenzene.

### TECHNICAL FIELD

The present disclosure relates to a resin composition and a production method therefor, and a cured product of the resin composition.

### BACKGROUND ART

Printed wiring boards and multilayer wiring boards using the printed wiring boards are used in products such as mobile communication device (for example, mobile phones and smartphones), and base station device thereof; network related electronic devices such as server routers; and large computers.

In recent years, high-frequency electric signals have been used in these products in order to transmit and process large-capacity information at high speed. However, since a high-frequency signal is very easily attenuated, an insulating material having excellent dielectric properties is required as an insulating material used for the printed wiring board and the multilayer wiring board in order to suppress a transmission loss.

As such an insulating material, an epoxy resin composition disclosed in Patent Literature 1 to 3 is known. Patent Literature 1 discloses that an epoxy resin composition containing an epoxy resin, an active ester compound, and a triazine-containing cresol novolac resin is effective for reducing the dielectric loss tangent. Patent Literature 2 and 3 disclose that a resin composition containing an epoxy resin and an active ester compound as essential components can form a cured product having a low dielectric loss tangent and is useful as an insulating material.

Meanwhile, Patent Literature 4 reports that a resin film formed of a resin composition containing a polymaleimide resin having a long chain alkyl group and a curing agent as a non-epoxy-based insulating material is excellent in dielectric properties (low relative permittivity and low dielectric loss tangent).

### CITATION LIST

### Patent Literature

Patent Literature 1: JP 2011-132507 A
Patent Literature 2: JP 2015-101626 A
Patent Literature 3: JP 2017-210527 A
Patent Literature 4: JP 2018-201024 A

### SUMMARY OF INVENTION

### Technical Problem

The polymaleimide resin is usually produced by reacting a tetracarboxylic dianhydride with a polyamine to obtain a polyimide resin, and then reacting the obtained polyimide resin with maleic anhydride. Incidentally, the present inventors have conducted studies particularly on a polymaleimide resin, and found that a side reaction may proceed, and it may be difficult to obtain a polymaleimide resin having a small dispersion degree.

Therefore, a main object of the present disclosure is to provide a method for producing a resin composition capable of suppressing side reactions in the production of a polymaleimide resin.

### Solution to Problem

As a result of intensive studies, in order to solve the above problems, the present inventors found that by using 1,2,4-trimethylbenzene, side reactions are suppressed, and a polymaleimide resin having a small dispersion degree tends to be easily obtained, thereby completing the invention of the present disclosure. According to the studies, the present inventors also found that the polymaleimide resin obtained in this manner tends to be easily dissolved in 1,2,4-trimethylbenzene.

The present disclosure provides a method for producing the resin composition according to [1] to [4], the resin composition according to [5] and [6], and a cured product of the resin composition according to [7].

[1] A method for producing a resin composition, the method including: obtaining a polyimide resin by reacting a tetracarboxylic dianhydride with a polyamine in an organic solvent; and obtaining a resin composition containing a polymaleimide resin and the organic solvent by reacting the polyimide resin with maleic anhydride, in which the polyamine contains dimer diamine, and the organic solvent contains 1,2,4-trimethylbenzene.
[2] The method for producing a resin composition according to [1], in which the dimer diamine is at least one selected from a group consisting of a compound represented by general Formula (1) described below and a compound represented by general Formula (2) described below.

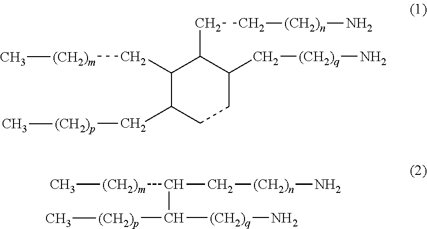

[In Formulae (1) and (2), m, n, p, and q each independently represent an integer of 1 or more. Here, m and n are integers satisfying a condition of m+n=6 to 17, and p and q are integers satisfying a condition of p+q=8 to 19. A bond indicated by a broken line represents a carbon-carbon single bond or a carbon-carbon double bond. However, when the bond indicated by the broken line is a carbon-carbon double bond, Formulae (1) and (2) have a structure in which the number of hydrogen atoms bonded to each carbon atom constituting the carbon-carbon double bond is subtracted by 1 from the numbers shown in Formulae (1) and (2).]

[3] The method for producing a resin composition according to [1] or [2], in which a blending amount of the dimer diamine is 20% by mol or more based on a total amount of the polyamine.
[4] The method for producing a resin composition according to any one of [1] to [3], in which a weight average molecular weight of the polymaleimide resin is 3,000 to 40,000.
[5] A resin composition containing: a polymaleimide resin that is a reaction product of a tetracarboxylic dianhydride, a polyamine, and maleic anhydride; and an organic solvent; in which the polyamine contains dimer diamine, and the organic solvent contains 1,2,4-trimethylbenzene.
[6] The resin composition according to [5], further containing a polymerization initiator, in which the polymerization initiator contains a thermal polymerization initiator or a photopolymerization initiator.
[7] A cured product of the resin composition according to [5] or [6].

### Advantageous Effects of Invention

According to the present disclosure, there is provided a method for producing a resin composition capable of suppressing a side reaction in production of a polymaleimide resin. Further, the present disclosure provides a resin composition obtained by such a production method and a cured product thereof.

### DESCRIPTION OF EMBODIMENTS

Hereinafter, embodiments of the present disclosure will be described in detail. However, the present disclosure is not limited to the following embodiments.

In the present specification, a numerical range indicated using “to” indicates a range including numerical values described before and after “to” as a minimum value and a maximum value, respectively. In the numerical range described in stages in the present specification, the upper limit value or the lower limit value of the numerical range of a certain stage may be replaced with the upper limit value or the lower limit value of the numerical range of another stage. In addition, in the numerical range described in the present specification, the upper limit value or the lower limit value of the numerical range may be replaced with a value shown in Examples. In addition, the upper limit value and the lower limit value described individually can be combined in any manner. In the notation “A to B”, the numerical values A and B at both ends are included in the numerical range as the lower limit value and the upper limit value, respectively. In the present specification, for example, the description of “10 or more” means “10” and “numerical values exceeding 10”, and the same applies to cases where numerical values are different. In addition, for example, the description of “10 or less” means “10” and “numerical values less than 10”, and the same applies to cases where numerical values are different.

In the present specification, the “polymaleimide resin” means a polyfunctional maleimide resin having two or more maleimide groups.

In the present specification, the “polyamine” means a polyfunctional amine having two or more amino groups.

In the present specification, the “(meth)acrylate” means at least one of an acrylate and a methacrylate corresponding thereto. The same applies to other similar expressions such as “(meth)acryloyl” and “(meth)acrylic acid”. In addition, “A or B” only needs to include either A or B, and may include both A and B.

The materials exemplified below may be used alone or in combination of two or more unless otherwise specified. The blending amount of each component in the method for producing a composition, the content of each component in the composition, and the like mean the total amount of a plurality of substances when there are a plurality of substances corresponding to each component unless otherwise specified.

### [Method for Producing Resin Composition]

A method for producing a resin composition according to the present embodiment includes: obtaining a polyimide resin by reacting a tetracarboxylic dianhydride (hereinafter, may be referred to as “component (a1)”) with a polyamine (hereinafter, may be referred to as “component (a2)”) in an organic solvent (hereinafter, may be referred to as “component (B)”) (hereinafter, may be referred to as “first step”); and obtaining a resin composition containing a polymaleimide resin (hereinafter, may be referred to as “component (A)”) and the component (B) by reacting the polyimide resin with maleic anhydride (hereinafter, may be referred to as “component (a3)”) (hereinafter, may be referred to as “second step”). The first step may be performing an imidization reaction of the component (a1) and the component (a2), and the second step may be performing a maleimidation reaction of the reaction products of the component (a1) and the component (a2) and the component (a3). The component (A) can also be referred to as a reaction product of the component (a1), the component (a2), and the component (a3).

### <First Step>

This step is obtaining a polyimide resin by reacting the component (a1) with the component (a2) in the component (B).

Examples of the component (a1) include pyromellitic anhydride, 4,4′-(hexafluoroisopropylidene)diphthalic anhydride, 1,3,3a,4,5,9b-hexahydro-5 (tetrahydro-2,5-dioxo-3-furanyl) naphtho[1,2-C]furan-1,3-dione, 4,4′-oxydiphthalic dianhydride, 3,3′,4,4′-diphenylsulfonetracarboxylic dianhydride, 3,3′,4,4′-biphenyltetracarboxylic dianhydride, 3,3′,4,4′-benzophenonetracarboxylic dianhydride, 4,4′-(4,4′-isopropylidenediphenoxy)diphthalic anhydride, 1,2,3,4-butanetetracarboxylic dianhydride, 1,2,3,4-cyclobutanetetracarboxylic dianhydride, 1,2,3,4-cyclopentanetetracarboxylic dianhydride, 1,2,3,4-tetramethyl-1,2,3,4-cyclobutanetetracarboxylic dianhydride, bicyclo[2.2.2]octo-7-ene-2,3,5,6-tetracarboxylic dianhydride, bis(1,3-dioxo-1,3-dihydroisobenzofuran-5-carboxylic acid) 1,4-phenylene, 9,9-bis(3,4-dicarboxyphenyl) fluorene dianhydride, 4,4′-(ethyne-1,2-diyl)diphthalic anhydride, 5-(2,5-dioxotetrahydrofuryl)-3-methyl-3 cyclohexene-1,2-dicarboxylic anhydride, dicyclohexyl-3,4,3′,4′-tetracarboxylic dianhydride, 3,4′-oxydiphthalic anhydride, 3,4′-biphthalic anhydride, norbornane-2-spiro-α-cyclopentanone-α′-spiro-2″-norbornane-5,5′,6,6″-tetracarboxylic dianhydride, and 5,5′-bis-2-norbornene-5,5′,6,6′-tetracarboxylic acid-5,5′,6,6′-dianhydride.

From the viewpoint of excellent dielectric properties or from the viewpoint of a high Tg (glass transition point), the component (a1) may contain at least one selected from the group consisting of pyromellitic anhydride, 4,4′-(hexafluoroisopropylidene)diphthalic anhydride, 1,3,3a,4,5,9b-hexahydro-5 (tetrahydro-2,5-dioxo-3-furanyl) naphtho[1,2-C]furan-1,3-dione, 3,3′,4,4′-biphenyltetracarboxylic dianhydride, bicyclo[2.2.2]oct-7-ene-2,3,5,6-tetracarboxylic dianhydride, 9,9-bis(3,4-dicarboxyphenyl) fluorene dianhydride, 5-(2,5-dioxotetrahydrofuryl)-3-methyl-3-cyclohexene-1,2-dicarboxylic anhydride, dicyclohexyl-3,4,3′,4′-tetracarboxylic dianhydride, 3,4′-biphthalic anhydride, and 5,5′-bis-2-norbornene-5,5′,6,6′-tetracarboxylic acid-5,5′,6,6′-dianhydride, may contain at least one selected from the group consisting of pyromellitic anhydride, 4,4′-(hexafluoroisopropylidene)diphthalic anhydride, 1,3,3a,4,5,9b-hexahydro-5 (tetrahydro-2,5-dioxo-3-furanyl) naphtho[1,2-C]furan-1,3-dione, 3,3′,4,4′-biphenyltetracarboxylic dianhydride, and 9,9-bis(3,4-dicarboxyphenyl) fluorene dianhydride, or may contain pyromellitic anhydride.

The component (a2) may contain a diamine (hereinafter may be referred to as “component (a2-1)”). The component (a2) may contain a triamine (hereinafter may be referred to as “component (a2-2)”) in addition to the component (a2-1).

Examples of the component (a2-1) include dimer diamine, 1,3-diaminopropane, norbornanediamine, 4,4-methylenedianiline, 1,3-bis[2-(4-aminophenyl)-2 propyl]benzene, 4,4′-diamino-2,2′-bis(trifluoromethyl) biphenyl, 2,2-bis[4-(4-aminophenoxy)phenyl]hexafluoropropane, 9,9-bis(4-aminophenyl) fluorene, 9,9-bis[4-(4-aminophenoxy)phenyl]fluorene, 1,3-bis(aminomethyl)cyclohexane, 1,4-bis(aminomethyl)cyclohexane, bis(aminomethyl) norbornane, 4,4′-(hexafluoroisopropylidene)dianiline, 3 (4), 8 (9)-bis(aminodimethyl)tricycl[5.2.1.02,6]decane, 1,3-cyclohexanediamine, 1,4-cyclohexanediamine, isophoronediamine, 4,4′-methylenebis(cyclohexylamine), 4,4′-methylenebis(2-methylcyclohexylamine), 1,1-bis(4-aminophenyl)cyclohexane, 2,7-diaminofluorene, 4,4′-ethylenedianiline, 4,4′-methylenebis(2,6-diethylaniline), 4,4′-methylenebis(2-ethyl-6-methylaniline), 2,2-bis[4-(4-aminophenoxy)phenyl]propane, bis[4-(4-aminophenoxy)phenyl]methane, 4,4′-bis(4-aminophenoxy) biphenyl, bis[4-(4-aminophenoxy)phenyl]ether, bis[4-(4-aminophenoxy)phenyl]ketone, 1,3-bis(4-aminophenoxy)benzene, 1,4-bis(4-aminophenoxy)benzene, 2,2′-dimethylbiphenyl-4,4′-diamine, ether, (3,3′-diamino)diphenyl ether, (4,4′-diamino)diphenyl paraphenylenediamine, orthophenylenediamine, meta-phenylenediamine, 2,2′-dimethylbiphenyl-4,4′-diamine, bis[4-(3-aminophenoxy)phenyl]sulfone, and bis[4-(4-aminophenoxy)phenyl]sulfone.

The component (a2) may contain dimer diamine as the component (a2-1). Here, the dimer diamine is, for example, a compound derived from dimer acid which is a dimer of an unsaturated fatty acid such as oleic acid. As the dimer diamine, a known dimer diamine can be used without particular limitation, and for example, the dimer diamine may be at least one selected from the group consisting of a compound represented by the following general Formula (1) and a compound represented by the following general Formula (2).

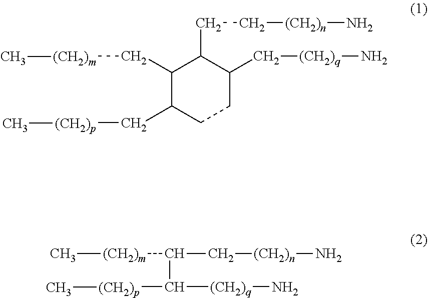

In the Formulae (1) and (2), m, n, p, and q each independently represent an integer of 1 or more, and may be an integer of 1 to 12. Here, m and n are integers satisfying a condition of m+n=6 to 17, and p and q are integers satisfying a condition of p+q=8 to 19. A bond indicated by a broken line represents a carbon-carbon single bond or a carbon-carbon double bond. However, when the bond indicated by the broken line is a carbon-carbon double bond, Formulae (1) and (2) have a structure in which the number of hydrogen atoms bonded to each carbon atom constituting the carbon-carbon double bond is subtracted by one from the numbers shown in the Formulae (1) and (2).

The dimer diamine may be a compound represented by the general Formula (1) or a compound represented by the following Formula (3) from the viewpoint of heat resistance, high Tg, dielectric properties, and the like.

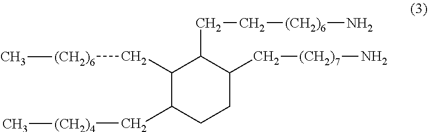

Examples of commercially available products of dimer diamine include PRIAMINE 1075 and PRIAMINE 1074 (a mixture containing both a compound represented by general Formula (1) and a compound represented by general Formula (2), both manufactured by Croda Japan K.K.).

The blending amount of the component (a2-1) may be 20 to 100% by mol, 40 to 100% by mol, 60 to 100% by mol, or 80 to 100% by mol based on the total amount of the component (a2).

The blending amount of the dimer diamine may be 20% by mol or more, 40% by mol or more, or 60% by mol or more, and may be 95% by mol or less, 90% by mol or less, or 80% by mol or less based on the total amount of the component (a2). When the content of the dimer diamine is in such a range, the cured product of the obtained resin composition tends to have more excellent dielectric properties.

Examples of the component (a2-2) include tris(2-aminomethyl)amine, tris(2-aminoethyl)amine, tris(2-aminopropyl)amine, 2-(aminomethyl)-2-methyl-1,3-propanediamine, trimer triamine, 3,4,4′-triaminodiphenyl ether, 1,2,4-triaminobenzene, 1,3,5-triaminobenzene, 1,2,3-triaminobenzene, 1,3,5-triazine-2,4,6-triamine, 2,4,6-triaminopyrimidine, 1,3,5-tris(4-aminophenyl)benzene, and 1,3,5-tris(4-aminophenoxy)benzene. Among them, the component (a2) may contain, as the component (a2-2), an aliphatic triamine from the viewpoint of the solubility of the component (A) in an organic solvent, and may contain tris(2-aminomethyl)amine or tris(2-aminoethyl)amine from the viewpoint of increasing the Tg.

The blending amount of the component (a2-2) may be 0 to 80% by mol, 0 to 60% by mol, 0 to 40% by mol, or 0 to 20% by mol based on the total amount of the component (a2).

When dimer diamine is used as the component (a2), the cured product of the obtained resin composition tends to have more excellent dielectric properties. On the other hand, when only dimer diamine is used as the component (a2), the Tg of the cured product of the resin composition may decrease. On the other hand, by using a diamine other than triamine or dimer diamine in combination, the Tg of the cured product can be improved while maintaining the dielectric properties of the cured product.

In the method for producing a resin composition, the molecular weight of the component (A) finally obtained can be controlled by the blending ratio of the component (a1) and the component (a2). The blending amount of the component (a1) may be 0.30 to 0.95 mol, 0.40 to 0.85 mol, or 0.50 to 0.80 mol with respect to 1.0 mol of the component (a2). When the blending amount of the component (a1) is 0.95 mol or less, maleimide groups that can be reacted and introduced can be increased, and there is a tendency that the component (A) that is easily cured when heated together with a thermal polymerization initiator or when irradiated with an active energy ray can be obtained. When the ratio of the component (a1) is 0.30 or more, a low molecular weight component can be reduced, and the component (A) having good heat resistance tends to be easily obtained.

The component (B) contains 1,2,4-trimethylbenzene (pseudocumene, boiling point: 169° C.) (hereinafter may be referred to as “component (b1)”). The component (b1) tends to easily dissolve the component (a3) used in the second step. According to the study of the present inventors, it has been found that by using the component (b1), side reactions are suppressed, and the component (A) having a small dispersion degree tends to be easily obtained. Further studies by the present inventors have also found that the component (A) obtained in this manner tends to be easily dissolved in the component (b1).

The dissolution amount (25° C.) of the component (a3) in the component (b1) may be, for example, 10 g or more with respect to 100 g of the component (b1). When the dissolution amount of the component (a3) in the component (b1) is 10 g or more with respect to 100 g of the component (b1), side reactions are suppressed, and the component (A) having a small dispersion degree tends to be easily obtained. In addition, the dissolution amount (25° C.) of the component (a3) in the component (b1) can be measured by, for example, the method of Examples to be described later.

The component (B) may contain alcohols (hereinafter may be referred to as “component (b2)”) for esterifying and dissolving the component (a1) in the imidization reaction in the first step. The component (b2) can be used without particular limitation as long as the component (b2) is a known alcohol. Examples of the component (b2) include methanol, ethanol, 1-propanol, isopropanol, 1-butanol, and benzyl alcohol. Among them, methanol or ethanol may be contained from the viewpoint of ease of desorption during imide ring closure. Here, the ease of hydrolysis of the ester generally depends on the number of carbon atoms (boiling point) of the alcohol, and the alcohol having a lower boiling point tends to have higher desorption ability and to be easily desorbed at the time of imide ring closure. By using the component (b2), the dehydration ring closure reaction in the first step can be further promoted, the reaction can be uniformly performed, and the component (A) having a high molecular weight and a low dispersion degree can be efficiently produced.

The amount of the component (b2) used is not particularly limited, but may be 2 mol or more or 2 to 16 mol with respect to 1 mol of the component (a1) from the viewpoint of more sufficiently obtaining the effect of promoting the dehydration ring closure reaction in the first step and making the reaction uniform. In addition, when the component (b2) is used in combination with the component (b1), the amount of the component (b2) used may be 0.1 to 40% by mass or may be 5 to 25% by mass based on the total amount of the component (B) from the same viewpoint as described above. In other words, when the component (b2) is used in combination with the component (b1), the amount of the component (b1) used may be 60 to 99.9% by mass or may be 75 to 95% by mass based on the total amount of the component (B).

The amount of the component (B) used is not particularly limited as long as the amount is an amount of synthesized component (A) that dissolves, but from the viewpoint of optimizing the viscosity and promoting the dehydration ring closure reaction, the amount may be such that the total concentration of components other than the component (B) in the reaction liquid obtained by mixing the component (a1), the component (a2), the component (B), and the like may be 10 to 70% by mass, or may be 20 to 60% by mass.

In the first step, first, in the component (B), the component (a1) and the component (a2) are subjected to a polyaddition reaction at a temperature of about 60 to 120° C., preferably 70 to 90° C., for usually about 0.1 to 2 hours, preferably 0.1 to 1.0 hours. Next, the obtained polyadduct is further subjected to an imidization reaction at a temperature of about 80 to 250° C., preferably 100 to 200° C., for about 0.5 to 30 hours, preferably 0.5 to 10 hours, that is, a dehydration ring closure reaction. That is, a polyimide resin as an intermediate can be obtained by dehydration ring closure reaction. The polyaddition reaction and the imidization reaction may be performed under any condition of atmospheric pressure (normal pressure), under reduced pressure, or under pressure. The pressure conditions for the polyaddition reaction and the imidization reaction may be, for example, normal pressure (0.00 MPa) to reduced pressure (−0.04 MPa). In addition, the polyaddition reaction and the imidization reaction may be performed while removing the component (b2) and the generated water as necessary.

### <Second Step>

This step is obtaining a resin composition containing the component (A) and the component (B) by reacting the component (a3) (maleic anhydride) with a polyimide resin.

The component (a3) is added to synthesize a polyimide resin as an intermediate in the first reaction step and then react with the polyimide resin in the second reaction step. The addition amount of the component (a3) may be 1.0 to 3.0 mol or may be 1.3 to 2.0 mol with respect to 1 mol of amino groups of the polyimide resin. When the addition amount of the component (a3) is 1.0 mol or more with respect to 1 mol of amino groups of the polyimide resin, side reactions can be further suppressed, and the heat resistance of the obtained component (A) tends to be improved. When the addition amount of the component (a3) is 3.0 mol or less with respect to 1 mol of amino groups of the polyimide resin, purification of the component (A) tends to be easy.

When the component (a2) is composed of the component (a2-1) (divalent diamine), for example, the amino group (mol) of the polyimide resin can be calculated based on the following Formula (X).

$$Amino group ( mol ) of polyimide resin = number of moles of component ( a 2 ) \times 2 - number of moles of component ( a 1 ) \times 2 ( X )$$

The addition rate of the component (a3) when adding the component (a3) to the polyimide resin may be 0.25 mol/min or more, 0.3 mol/min or more, 0.5 mol/min or more, 0.7 mol/min or more, 1.0 mol/min or more, 1.2 mol/min or more, 1.5 mol/min or more, 1.7 mol/min or more, 2.0 mol/min or more, 2.2 mol/min or more, or 2.5 mol/min or more with respect to 1 mol of amino groups of the polyimide resin. When the addition rate when the component (a3) is added to the polyimide resin is sufficiently high, the progress of the side reaction is suppressed, and the component (A) having a small dispersion degree tends to be easily obtained. The addition rate of the component (a3) may be, for example, 9.0 mol/min or less, 8.0 mol/min or less, 7.0 mol/min or less, 6.0 mol/min or less, or 5.0 mol/min or less with respect to 1 mol of amino groups of the polyimide resin. The addition rate of the component (a3) when adding the component (a3) to the polyimide resin may be, for example, an addition rate when adding 1 mol or more (for example, 1.5 mol) of the component (a3) to 1 mol of amino groups of the polyimide resin.

In the second step, the component (a3) is added to the polyimide resin obtained in the first step, and the polyimide resin and the component (a3) are subjected to a maleimidation reaction at a temperature of about 60 to 250° C., preferably 80 to 200° C., for about 0.5 to 30 hours, preferably 0.5 to 10 hours, that is, a dehydration ring closure reaction, whereby a resin composition containing the intended components (A) and (B) can be obtained. The maleimidation reaction may be performed under any condition of atmospheric pressure (normal pressure), under reduced pressure, or under pressure. The pressure condition of the maleimidation reaction may be, for example, normal pressure (0.00 MPa) to reduced pressure (−0.04 MPa). The maleimidation reaction may be performed while removing the component (b2) and the generated water as necessary.

In the first step and the second step, various known reaction catalysts and dehydrating agents may be used. Examples of the reaction catalyst include aliphatic tertiary amines such as triethylamine, aromatic tertiary amines such as dimethylaniline, heterocyclic tertiary amines such as pyridine, picoline, and isoquinoline, and organic acids such as methanesulfonic acid, p-toluenesulfonic acid monohydrate, and trifluoromethanesulfonic acid. Examples of the dehydrating agent include aliphatic acid anhydrides such as acetic anhydride and aromatic acid anhydrides such as benzoic anhydride.

The obtained resin composition may be purified by various known methods. The purity of the component (A) in the resin composition can be increased by purifying the obtained resin composition. Examples of the purification of the resin composition include a method using a separatory funnel. In the method, first, the resin composition and water are placed in a separating funnel, and the mixed liquid in the separatory funnel is shaken. Subsequently, by separating the aqueous layer and the organic layer and recovering the organic layer, the purity of the component (A) can be increased while removing the component (b2).

In this manner, a resin composition containing the component (A), which is a reaction product of the component (a1), the component (a2), and the component (a3), and the component (B) can be obtained.

Hereinafter, an example of the component (A) obtained by the above production method will be described. The component (A) may be, for example, a polymaleimide resin represented by the following general Formula (4) or a polymaleimide resin represented by the following general Formula (5). In one embodiment, the polymaleimide resin represented by the general Formula (4) and the polymaleimide resin represented by the general Formula (5) may be a bismaleimide resin.

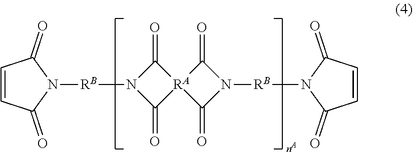

In the Formula (4), R^{A} represents a tetravalent organic group. R^{B} represents a divalent organic group which may have a maleimide group. n^{A} represents an integer of 0 to 100. When n^{A} is one or more, a plurality of R^{A}_{S} may be the same as or different from each other, and a plurality of R^{B}_{S} may be the same as or different from each other. n^{A} may be an integer of 1 to 30.

R^{A} may be a substituted or unsubstituted aliphatic hydrocarbon group, a substituted or unsubstituted heteroaliphatic hydrocarbon group, a substituted or unsubstituted aromatic hydrocarbon group, or a tetravalent organic group having a substituted or unsubstituted heteroaromatic hydrocarbon group. The aliphatic hydrocarbon group may be an alicyclic hydrocarbon group. The tetravalent organic group may be an organic group having 4 to 30 carbon atoms. Examples of the tetravalent organic group represented by R¹ include aromatic hydrocarbons (aryl) such as benzene, naphthalene, perylene, and biphenyl; compounds having an aromatic hydrocarbon group, such as diphenyl ether, diphenyl sulfone, diphenyl propane, diphenyl hexafluoropropane, and benzophenone; heteroaromatic hydrocarbon such as pyrrole, furan, thiophene, oxazole, thiazole, pyridine, primidine, quinoline, coumarin, indole, benzofuran, acridine, phenoxazine, and carbazole; compound having heteroaromatic hydrocarbon group such as dipyridyl disulfide; aliphatic hydrocarbon (alkane) such as butane, cyclobutane, or cyclopentane; a group obtained by removing four hydrogen atoms from a compound such as a heteroaliphatic hydrocarbon such as piperidine, piperazine, morpholine, or pyrrolidine. The compound having an aromatic hydrocarbon group may be a group obtained by removing four hydrogen atoms from an aromatic hydrocarbon. The tetravalent organic group represented by R¹ may be a group obtained by removing four hydrogen atoms from an aromatic hydrocarbon, or may be a group obtained by removing four hydrogen atoms from benzene or biphenyl, from the viewpoint of improving the heat resistance of the obtained bismaleimide resin and making the bismaleimide resin easily available.

R^{B} may be a substituted or unsubstituted aliphatic hydrocarbon group, a substituted or unsubstituted heteroaliphatic hydrocarbon group, a substituted or unsubstituted aromatic hydrocarbon group, or a divalent organic group having a substituted or unsubstituted heteroaromatic hydrocarbon group. Here, the divalent organic group may be an organic group having 4 to 100 carbon atoms or an organic group having 4 to 60 carbon atoms. Note that R^{B} is a residue of the component (a2) (polyamines such as diamines and triamines). The residue of the component (a2) may include dimer diamine residue.

When the polymaleimide resin represented by the general Formula (4) is a bismaleimide resin having two maleimide groups, R^{B} is a divalent organic group having no maleimide group. When the polymaleimide resin represented by the general Formula (4) is a polymaleimide resin having three or more maleimide groups, at least a part of R^{B} is a divalent organic group having a maleimide group in which a part of hydrogen atoms of the divalent organic group is substituted with a maleimide group.

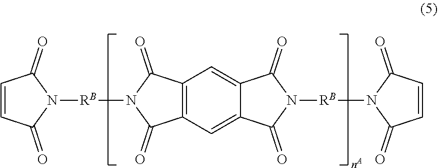

In Formula (5), R^{B} and n^{A} have the same meaning as R^{B} and n^{A} described above.

The weight average molecular weight (Mw) of the component (A) may be 3,000 to 40,000, 6,000 to 25,000, or 9,000 to 20,000 from the viewpoint of solubility in a solvent and heat resistance. When the Mw of the component (A) is 40,000 or less, solubility in the component (B) tends to be good. When the Mw of the component (A) is 3,000 or more, the effect of improving the heat resistance tends to be sufficiently obtained.

The number average molecular weight (Mn) of the component (A) may be 1,000 to 12,000, 2,000 to 8,000, or 4,000 to 6,000 from the viewpoint of solubility in a solvent and heat resistance. When the Mn of the component (A) is 12,000 or less, solubility in the component (B) tends to be good. When the Mn of the component (A) is 1,000 or more, the effect of improving the heat resistance tends to be sufficiently obtained.

In the present specification, the Mw and Mn of the component (A) mean polystyrene equivalent values using a calibration curve by standard polystyrene by a gel permeation chromatography method (GPC).

The dispersion degree (Mw/Mn) of the component (A) may be, for example, less than 3.5, and may be 3.3 or less, 3.2 or less, 3.1 or less, 3.0 or less, 2.9 or less, 2.8 or less, 2.7 or less, 2.6 or less, or 2.5 or less. According to the method for producing a resin composition of the present embodiment, since the progress of side reactions can be suppressed, the dispersion degree of the component (A) tends to decrease. In addition, when the dispersion degree of the component (A) is less than 3.5, solubility in the component (B) tends to be good. The dispersion degree of the component (A) may be, for example, 1.0 or more, 1.5 or more, or 2.0 or more.

The components (A) can be cured by heating and/or irradiation with active energy rays.

The component (A) can be cured by heating at a temperature of usually about 150 to 250° C., preferably 180 to 220° C., for usually about 0.1 to 3 hours, preferably 0.1 to 1.5 hours.

When the component (A) is cured by irradiation with an active energy ray, examples of the active energy ray include visible rays, ultraviolet rays, X-rays, electron beams, and the like. The active energy ray may be an ultraviolet ray because an inexpensive device can be used. Examples of the light source in the case of using ultraviolet rays include ultrahigh pressure, high pressure, intermediate pressure, and low pressure mercury lamps; metal halide lamp; xenon lamp; electrodeless discharge lamp; and carbon arc lamp. Irradiation with active energy rays may be from a few seconds to a few minutes.

### [Resin Composition]

A resin composition according to the present embodiment contains the component (A), which is a reaction product of the component (a1), the component (a2), and the component (a3), and the component (B). The resin composition can be obtained by the above-described production method. The resin composition can also be obtained by isolating the component (A) from the resin composition obtained by the above production method, and mixing the isolated component (A) with the component (B).

In the resin composition, the content of the component (A) may be 10 to 70% by mass or 20 to 60% by mass based on the total amount of the resin composition. The content of the component (A) can be adjusted by increasing or decreasing the amount of the component (B) (mainly the component (b1)).

In the resin composition, the main component of the component (B) may be the component (b1). The content of the component (b1) may be 70% by mass or more, 80% by mass or more, 90% by mass or more, or 95% by mass or more based on the total amount of the component (B).

The resin composition may further contain a polymerization initiator (hereinafter may be referred to as “component (C)”). The component (C) may contain a thermal polymerization initiator (hereinafter may be referred to as “component (c1)”) or a photopolymerization initiator (hereinafter may be referred to as “component (c2)”).

Examples of the component (c1) include an organic peroxide, an imidazole compound, a phosphine compound, and a phosphonium salt compound. Among them, the component (c1) may be an organic peroxide or an imidazole compound from the viewpoint of a function as a polymerization initiator and excellent dielectric properties.

Examples of the organic peroxide include methyl ethyl ketone peroxide, methyl cyclohexanone peroxide, methyl acetoacetate peroxide, acetyl acetone peroxide, 1,1-bis(t-butylperoxy)-3,3,5-trimethylcyclohexane, 1,1-bis(t-hexylperoxy)cyclohexane, 1,1-bis(t-hexylperoxy)-3,3,5-trimethylcyclohexane, 1,1-bis(t-butylperoxy)cyclohexane, 2,2-bis(4,4-di-t-butylperoxycyclohexyl)propane, 1,1-bis(t-butylperoxy)cyclododecane, n-butyl-4,4-bis(t-butylperoxy) valerate, 2,2-bis(t-butylperoxy) butane, 1,1-bis(t-butylperoxy)-2-methylcyclohexane, t-butyl hydroperoxide, p-menthane hydroperoxide, 1,1,3,3-tetramethylbutyl hydroperoxide, t-hexyl hydroperoxide, dicumyl peroxide, 2,5-dimethyl-2,5-bis(t-butylperoxy)hexane, α,α′-bis(t-butylperoxy)diisopropylbenzene, t-butylcumyl peroxide, di-t-butyl peroxide, 2,5-dimethyl-2,5-bis(t-butylperoxy) hexyne-3, isobutyryl peroxide, 3,5,5-trimethylhexanoyl peroxide, octanoyl peroxide, lauroyl peroxide, cinnamic acid peroxide, m-toluoyl peroxide, benzoyl peroxide, diisopropylperoxydicarbonate, bis(4-t-butylcyclohexyl) peroxydicarbonate, di-3-methoxybutylperoxydicarbonate, di-2-ethylhexylperoxydicarbonate, di-sec-butylperoxydicarbonate, di(3-methyl-3 methoxybutyl) peroxydicarbonate, di(4-t-butylcyclohexyl) peroxydicarbonate, α,α′-bis(neodecanoylperoxy)diisopropylbenzene, cumylperoxy neodecanoate, 1,1,3,3-tetramethylbutylperoxy neodecanoate, 1-cyclohexyl-1-methylethylperoxy neodecanoate, t-hexylperoxy neodecanoate, t-butylperoxy neodecanoate, t-hexylperoxy pivalate, t-butylperoxy pivalate, 2,5-dimethyl-2,5-bis(2-ethylhexanoylperoxy) hexane, 1,1,3,3-tetramethylbutylperoxy-2-ethyl hexanoate, 1-cyclohexyl-1-methylethylperoxy-2-ethylhexanoate, t-hexylperoxy-2-ethylhexanoate, t-butylperoxy-2-ethylhexanoate, t-butylperoxyisobutyrate, t-butylperoxymaleic acid, t-butylperoxylaurate, t-butylperoxy-3,5,5-trimethylhexanoate, t-butylperoxyisopropyl monocarbonate, t-butylperoxy-2-ethylhexyl monocarbonate, 2,5-dimethyl-2,5-bis(benzoylperoxy) hexane, t-butylperoxyacetate, t-hexylperoxybenzoate, t-butylperoxy-m-toluoyl benzoate, t-butylperoxybenzoate, bis(t-butylperoxy) isophthalate, t-butylperoxyallyl monocarbonate, and 3,3′,4,4′-tetra(t-butylperoxycarbonyl)benzophenone. Among them, the organic peroxide may be dicumyl peroxide, 2,5-dimethyl-2,5-bis(t-butylperoxy)hexane, or α,α′-bis(t-butylperoxy)diisopropylbenzene.

Examples of the imidazole compound include 2-ethyl-4-methylimidazole, 2-methylimidazole, 2-ethylimidazole, 2,4-dimethylimidazole, 2-undecylimidazole, 2-heptadecylimidazole, 2-phenylimidazole, 2-phenyl-4-methylimidazole, 1-benzyl-2-methylimidazole, 2-phenyl-4,5-dihydroxymethylimidazole, 2-phenyl-4-methyl-5-hydroxymethylimidazole, 1-vinyl-2-methylimidazole, 1-propyl-2-methylimidazole, 2-isopropylimidazole, 1-cyanomethyl-2-methylimidazole, 1-cyanoethyl-2-ethyl-4-methylimidazole, 1-cyanoethyl-2-undecylimidazole, and 1-cyanoethyl-2-phenylimidazole. Among them, the imidazole compound may be 1-cyanoethyl-2-phenylimidazole or 2-ethyl-4 methylimidazole.

Examples of the phosphine compound include a primary phosphine, a secondary phosphine, and a tertiary phosphine. Examples of the primary phosphine include alkylphosphines such as ethylphosphine and propylphosphine; and phenylphosphine. Examples of the secondary phosphine include dialkylphosphines such as dimethylphosphine and diethylphosphine; diphenylphosphine; methylphenylphosphine; and ethylphenylphosphine. Examples of the tertiary phosphine include trialkylphosphines such as trimethylphosphine, triethylphosphine, tributylphosphine, and trioctylphosphine; tricyclohexylphosphine; triphenylphosphine; alkyldiphenylphosphine; dialkylphenylphosphine; tribenzylphosphine; tritolylphosphine; tri-p-styrylphosphine; tris(2,6-dimethoxyphenyl)phosphine; tri-4-methylphenylphosphine; tri-4-methoxyphenylphosphine; and tri-2-cyanoethylphosphine. The phosphine compound may be a tertiary phosphine.

Examples of the phosphonium salt compound include compounds having a tetraphenylphosphonium salt, an alkyltriphenylphosphonium salt, a tetraalkylphosphonium salt, and the like. Examples of the phosphonium salt compound include tetraphenylphosphonium-thiocyanate, tetraphenylphosphonium-tetra-p-methylphenylborate, butyltriphenylphosphonium-thiocyanate, tetraphenylphosphonium-phthalic acid, tetrabutylphosphonium-1,2-cyclohexyldicarboxylic acid, tetrabutylphosphonium-1,2-cyclohexyldicarboxylic acid, and tetrabutylphosphonium-lauric acid.

Examples of the component (c2) include acetophenone, 2,2-dimethoxyacetophenone, p-dimethylaminoacetophenone, Michler's ketone, benzyl, benzoin, benzoin methyl ether, benzoin ethyl ether, benzoin isopropyl ether, benzoin n-propyl ether, benzoin isopropyl ether, benzoin n-butyl ether, benzyl dimethyl ketal, thioxaton, 2-chlorothioxazone, 2-methylthioxaton, 2,2-dimethoxy-1,2-diphenylethane-1-one, 1-hydroxy-cyclohexyl-phenyl-ketone, 2-hydroxy-2-methyl-1-phenyl-propane-1-one, 1-[4-(2-hydroxyethoxy)-phenyl]-2-hydroxy-2-methyl-1-propane-1-one, 2-hydroxy-1-{4-[4-(2-hydroxy-2-methyl-propionyl)-benzyl]phenyl}-2-methyl-propane-2-one, 2-methyl-1-(4-methylthiophenyl)-2-morpholinopropane-1-one, 2-benzyl-2-dimethylamino-1-(4-morpholinophenyl)-1-butanone, 2,4,6-trimethylbenzoyl-diphenyl-phosphine oxide, bis(2,4,6-trimethylbenzoyl)-phenylphosphine oxide, 1,2-octanedione, 1-[4-(phenylthio)phenyl]-,2-(O-benzoyloxime), ethanone, 1-[9-ethyl-6-(2-methylbenzoyl)-9H-carbazole-3-yl]-, 1-(O-acetyloxime), and 2,4-dimethylthioxanthone.

Among these, the component (c2) may be a photopolymerization initiator that efficiently generates radicals at an exposure wavelength of 310 to 436 nm (more preferably 365 nm) from the viewpoint that a fine pattern can be formed using a reduction projection exposure machine (stepper, light source wavelength: 365 nm, 436 nm) that is typically used in a process of producing a semiconductor protective film or the like. The component (c2) may be a compound having an oxime structure or a thioxanthone structure from the viewpoint of reactivity.

Examples of the component (c2) which is a compound having an oxime structure or a thioxanthone structure include 1,2-octanedione, 1-[4-(phenylthio)phenyl]-,2-(O-benzoyloxime) (IRGACURE OXE-01 manufactured by BASF Japan Ltd.), ethanone, 1-[9-ethyl-6-(2-methylbenzoyl)-9H-carbazole-3 yl]-,1-(O-acetyloxime) (IRGACURE manufactured by BASF Japan Ltd.); and 2,4-OXE-02 dimethylthioxanthone (DETX-S manufactured by Nippon Kayaku Co., Ltd.) having a thioxanthone structure.

The content of the component (C) is not particularly limited, but may be 0.1 to 10 parts by mass, 0.5 to 5 parts by mass, or 0.7 to 3 parts by mass with respect to 100 parts by mass of the total amount of the component (A).

The resin composition may further contain other components other than the component (A), the component (B), and the component (C). Examples of other components include additives such as a mold release agent, a flame retardant, an ion trapping agent, an antioxidant, an adhesion imparting agent, a low stress agent, a colorant, a coupling agent, and an inorganic filler; resins other than the component (A), such as an epoxy resin, an acrylate compound, a vinyl compound, a benzoxazine compound, and a bismaleimide compound. The content of other components is not particularly limited as long as the effects of the present disclosure are not impaired, but may be 0.1 to 30 parts by mass with respect to 100 parts by mass of the total amount of the component (A).

### [Cured Product of Resin Composition]

The cured product of the resin composition of the present embodiment can be obtained by curing the resin composition. More specifically, the cured product of the resin composition can be obtained by a method including: obtaining a coating film (coated product) by coating the substrate with the resin composition; obtaining a dried film (dried product) by volatilizing an organic solvent from the coating film; and obtaining a cured film (cured product) by curing the dried film by heating and/or irradiation with an active energy ray. The cured product of the resin composition of the present embodiment tends to have relatively low surface roughness.

The substrate may be an organic substrate or an inorganic substrate. Examples of the organic substrate include polyimide; polyimide-silica hybrid; polyamide; polyethylene (PE); polypropylene (PP); polyethylene terephthalate (PET); polyethylene naphthalate (PEN); polymethyl methacrylate resin (PMMA); polystyrene resin (PSt); polycarbonate resin (PC); acrylonitrile-butadiene-styrene resin (ABS); ethylene terephthalate; and a film of an aromatic polyester resin (liquid crystal polymer, VECSTAR (manufactured by Kuraray Co., Ltd.), and the like) obtained from phenol, phthalic acid, hydroxynaphthoic acid, or the like and parahydroxybenzoic acid. Examples of the inorganic substrate include glass; metals such as iron, aluminum, 42 alloy, and copper; ITO; silicon; a silicon carbide substrate. The thickness of the substrate can be appropriately set according to the application. When an organic substrate is used as the substrate, the thickness of the organic substrate may be, for example, 1 to 250 μm.

Examples of the method of coating the substrate with the resin composition include a method of applying the resin composition using a knife coater, a roll coater, an applicator, a comma coater, a die coater, or the like. The thickness of the cured film (cured product) can be adjusted by adjusting the coating amount of the resin composition.

Heating conditions for volatilizing the organic solvent from the coating film can be appropriately set according to the organic solvent to be used and the like. The heating condition may be, for example, a heating time of 0.1 to 30 minutes at a heating temperature of 40 to 150° C.

The heating condition for curing the dried film or the irradiation condition of the active energy ray may be the same as the heating condition for curing the component (A) or the irradiation condition of the active energy ray.

The shape of the cured film (cured product) of the resin composition is not particularly limited, but when the resin composition is subjected to application for bonding a substrate, the cured film (cured product) can have a film thickness of usually about 1 to 200 μm, preferably about 3 to 100 μm in the form of a sheet. The film thickness of the cured film (cured product) of the resin composition can be appropriately adjusted according to the application.

### [Adhesive Sheet]

The adhesive sheet of the present embodiment includes a substrate (first substrate) and a dried film obtained by volatilizing an organic solvent from the resin composition. The substrate (first substrate) may be the same as the substrate exemplified in the cured product of the resin composition. The thickness of the dried film may be, for example, 1 to 200 μm or 3 to 100 μm.

### [Laminate]

The laminate of the present embodiment can be obtained by further thermocompression-bonding a substrate (second substrate) onto the adhesive surface (surface of the dried film) of the adhesive sheet. The substrate (second substrate) may be the same as the substrate exemplified in the cured product of the resin composition. The laminate of the present embodiment may be subjected to a curing treatment under the heating condition for curing the dried film or the irradiation condition of the active energy ray.

### [Printed Circuit Board and Printed Wiring Board]

The printed circuit board of the present embodiment may be one using the above adhesive sheet or one using the above laminate. The printed circuit board of the present embodiment can be obtained, for example, by further bonding the adhesive surface (surface of the dried film) of the adhesive sheet to the inorganic substrate surface of the laminate. The printed circuit board may use a polyimide film as an organic substrate and a metal foil (particularly a copper foil) as an inorganic substrate. By using such a printed circuit board, a circuit can be formed by subjecting the metal surface of the printed circuit board to a soft etching treatment, and a printed wiring board can be obtained by further bonding the adhesive sheet on the circuit and performing hot pressing.

Hereinafter, the present disclosure will be specifically described with reference to examples, but the present disclosure is not limited to these examples.

### [Production of Resin Composition]

### Example 1-1

Into a 1 L flask vessel equipped with a condenser, a nitrogen inlet tube, a heat transfer pair, a stirrer, and a vacuum pump, 54.68 parts by mass of pyromellitic anhydride (manufactured by Daicel Corporation), 432.92 parts by mass of pseudocumene (manufactured by Toyo Gosei Co., Ltd.), and 94.78 parts by mass of Solmix A-11 (trade name, manufactured by Nippon Alcohol Sales Co., Ltd., alcohol-based solvent containing ethanol as a main agent) were put. After charging, the temperature was raised to 80° C., the mixture was kept warm for 0.5 hours, and 179.46 parts by mass of dimer diamine (trade name: PRIAMINE 1075, manufactured by Croda Japan K.K.) was added dropwise. After the dropwise addition, the mixture was kept at 80° C. for 0.5 hours, and then 6.42 parts by mass of an aqueous methanesulfonic acid solution (70% aqueous solution, trade name: Lutropur MSA, manufactured by BASF SE) was added. Thereafter, the pressure in the reaction vessel was reduced from atmospheric pressure to 0.03 MPa (−0.03 MPa), and the temperature was raised to 160° C. while removing the alcohol-based solvent in the reaction liquid. After raising the temperature, a dehydration ring closure reaction was performed at 160° C. for 2 hours to remove water and an alcohol-based solvent in the reaction liquid, thereby obtaining a solution containing a polyimide resin as an intermediate. Subsequently, the inside of the reaction vessel was brought to atmospheric pressure, the solution containing the obtained polyimide resin was cooled to 130° C., and 24.58 parts by mass of maleic anhydride (manufactured by FUSO CHEMICAL CO., LTD.) was added at an addition rate of 2.9 mol/min with respect to 1 mol of amino groups of the polyimide resin. Thereafter, the pressure in the reaction vessel was reduced from atmospheric pressure to 0.03 MPa (−0.03 MPa), and the temperature was raised to 160° C. After raising the temperature, a dehydration ring closure reaction was performed at 160° C. for 4 hours to remove water in the reaction liquid, thereby obtaining a solution containing a polymaleimide resin.

The obtained solution containing the polymaleimide resin was placed in a separatory funnel, 1,200 parts by mass of pure water was added thereto, and the separatory funnel was shaken and allowed to stand. After standing, the organic layer and the aqueous layer were separated, and then only the organic layer was recovered. The recovered organic layer was put into a 1 L glass container equipped with a cooler, a nitrogen introduction tube, a heat transfer pair, a stirrer, and a vacuum pump, and the temperature was raised to 88 to 93° C. to remove water, and then the temperature was raised to 100° C. to partially remove the solvent for 0.5 hours in a state where the pressure was reduced from atmospheric pressure to 0.1 MPa, thereby obtaining a resin composition of Example 1-1 containing the polymaleimide resin (A-1) and the organic solvent.

### Example 1-2

A resin composition of Example 1-2 containing a polymaleimide resin (A-2) and an organic solvent was obtained in the same manner as in Example 1-1 except that the addition rate of maleic anhydride was changed to 0.5 mol/min with respect to 1 mol of amino groups of the polyimide resin.

### Example 1-3

A resin composition of Example 1-3 containing a polymaleimide resin (A-3) and an organic solvent was obtained in the same manner as in Example 1-1 except that pyromellitic anhydride was changed to 1,3,3a,4,5,9b-hexahydro-5 (tetrahydro-2,5-dioxo-3-furanyl) naphtho[1,2-C]furan-1,3-dione (trade name: TDA-100, manufactured by New Japan Chemical Co., Ltd.), the blending amount of each component was changed as shown in Table 1, and further, the addition rate of maleic anhydride was changed to 0.5 mol/min with respect to 1 mol of amino groups of the polyimide resin.

### Comparative Example 1-1

A resin composition of Comparative Example 1-1 containing the polymaleimide resin (a-1) and an organic solvent was obtained in the same manner as in Example 1-1 except that pseudocumene was changed to 1,2,3,4-tetrahydronaphthalene (tetralin, manufactured by FUJIFILM Wako Pure Chemical Corporation), and the pressure condition in the reaction vessel was changed as shown in Table 1.

### Comparative Example 1-2

Production of a resin composition was examined in the same manner as in Example 1-1 except that pseudocumene was changed to cyclohexanone (manufactured by FUJIFILM Wako Pure Chemical Corporation), and the pressure condition in the reaction vessel was changed as shown in Table 1. However, cyclohexanone was involved in the reaction and no polymaleimide resin was obtained.

### [Evaluation of Organic Solvent]

The organic solvents (pseudocumene, tetralin, and cyclohexanone) used in Examples and Comparative Examples were evaluated as follows.

### <Dissolution Amount of Maleic Anhydride in Organic Solvent>

To a 20 mL screw tube, 2 g of maleic anhydride and 10 g of each of the pseudocumene (Examples 1-1 to 1-3), tetralin (Comparative Example 1-1), and cyclohexanone (Comparative Example 1-2) used in Examples and Comparative Examples were added, and the mixture was mixed in a mix rotor at room temperature (25° C.) and a rotation speed of 70 rpm for 4 hours. After mixing, the mixture was allowed to stand for 1 hour or more, and then 20 mg of the supernatant and 0.6 mL of deuterated chloroform were injected into an NMR tube to prepare a sample. 1H-NMR was measured using a nuclear magnetic resonance apparatus (manufactured by Bruker Japan K.K.) under the conditions of a frequency of 400 MHz and a number of integrations of 16 times, and the dissolution amount of maleic anhydride in 100 g of the organic solvent was calculated from the peak integration ratio of maleic anhydride and the organic solvent. A case where the dissolution amount of the maleic anhydride was 10 g or more with respect to 100 g of the organic solvent was evaluated as “A” because the dissolution amount of the maleic anhydride in the organic solvent was excellent, and a case where the dissolution amount of the maleic anhydride in the organic solvent was less than 10 g was evaluated as “C”.

### [Evaluation of Resin Composition]

The resin compositions of Examples and Comparative Examples were evaluated as follows.

### <Ratio of Nonvolatile Content (NV)>

0.75 g±0.25 g of the resin composition was weighed on a metal petri dish with a precision balance. Thereafter, drying was performed at 150° C. for 0.5 hours with a hot air dryer, and the ratio of the nonvolatile content (NV) was calculated by the following formula. The results are shown in Table 1.

$$NV ( mass \% ) = \{ ( W 3 - W 1 ) / W 2 \} \times 100$$

W1: mass of empty metal petri dish (g)
W2: mass of resin composition before drying (g)
W3: total mass (g) of dried resin composition and metal petri dish

### <Weight Average Molecular Weight (Mw), Number Average Molecular Weight (Mn), and DispersionDegree (Mw/Mn)>

The Mw and Mn of the polymaleimide resin were measured by gel permeation chromatography (GPC). 50 μL of a sample obtained by dissolving a polymaleimide resin in tetrahydrofuran (THF) to have a concentration of 3% by mass was injected into a column (1× 420 GL-R, 1×430 GL-R, and 1×440 GL-R (all manufactured by Hitachi High-Tech Fielding Corporation)) heated to 30° C., and measurement was performed under the condition of a flow rate of 1.6 mL/min using THF as a developing solvent. The Mw and Mn of the polymaleimide resin were converted from the elution time by a molecular weight/elution time curve prepared using standard polystyrene (manufactured by Tosoh Corporation) using an L-3350 RI detector (manufactured by Hitachi, Ltd.) as a detector. From these, Mw/Mn was determined. The results are shown in Table 1.

TABLE 1

| | | | | | | Comp. | Comp. |
|---|---|---|---|---|---|---|---|
| | | | Exam. 1-1 | Exam. 1-2 | Exam. 1-3 | Exam. 1-1 | Exam. 1-2 |
| Component (a1) | Pyromellitic anhydride | | 54.68 | 54.68 | — | 54.68 | 54.68 |
| | TDA-100 | | — | — | 72.22 | — | — |
| Component (a2) | Dimer diamine | | 179.46 | 179.46 | 172.34 | 179.46 | 179.46 |
| Component (a3) | Maleic anhydride | | 24.58 | 24.58 | 23.61 | 24.58 | 24.58 |
| Reaction catalyst | Methanesulfonic acid aqueous solution | | 6.42 | 6.42 | 6.17 | 6.42 | 6.42 |
| Component (B) | Component | Pseudocumene | 432.92 | 432.92 | 432.92 | — | — |
| | (b1) | Tetralin | — | — | — | 432.92 | — |
| | | Cyclohexanone | — | — | — | — | 432.92 |
| | Component | Solmix A-11 | 94.78 | 94.78 | 94.78 | 94.78 | 94.78 |
| | (b2) | | | | | | |

| Boiling point of component (b1) (° C.) | 169 | 169 | 169 | 207 | 156 |
|---|---|---|---|---|---|
| Dissolution amount of component (a3) in component (b1) | A | A | A | C | — |
| Pressure at the time of synthesis (MPa) | −0.03 | −0.03 | −0.03 | −0.085 | +0.03 |
| | (reduced | (reduced | (reduced | (reduced | (pressurized) |
| | pressure) | pressure) | pressure) | pressure) | |
| Addition rate of component (a3) (mol/min) (with respect to 1 | 2.9 | 0.5 | 0.5 | 2.9 | 2.9 |
| mol of amino groups of polyimide resin) | | | | | |
| NV (% by mass) | 55.1 | 54.5 | 56.2 | 35.4 | — |
| Mw of polymaleimide resin | 17300 | 18600 | 13900 | 25300 | — |
| Mn of polymaleimide resin | 5700 | 5900 | 4900 | 7200 | — |
| Mw/Mn of polymaleimide resin | 3.0 | 3.2 | 2.8 | 3.5 | — |

As shown in Table 1, it was found that in the production of the resin compositions of Examples 1-1 to 1-3 using pseudocumene, the dispersion degree of the obtained polymaleimide resin was smaller than that in the production of the resin composition of Comparative Examples using pseudocumene. The reason why the dispersion degree of the polymaleimide resin was large in the production of the resin composition of Comparative Example 1-1 is presumed to be that the dissolution amount of maleic anhydride in tetralin was low, and side reaction proceeded to increase the molecular weight. From the above, it was confirmed that the method for producing a resin composition of the present disclosure can suppress side reactions.

### [Preparation of Resin Composition]

### Example 2-1

A resin composition of Example 2-1 was prepared by adding 0.55 parts by mass of DCP (dicumyl peroxide, trade name: PERCUMYL D, manufactured by NOF CORPORATION) to 100 parts by mass of the resin composition of Example 1-1 (polymaleimide resin (A-2): 55.1 parts by mass, organic solvent (mainly pseudocumene): 44.9 parts by mass).

### [Preparation of Adhesive Sheet]

An adhesive sheet was prepared using the resin composition of Example 2-1. For preparation of an adhesive sheet, the resin composition was applied onto a film biner (registered trademark) (PET film, manufactured by FUJIMORI KOGYO CO., LTD., trade name: NS14, film thickness: 75 μm) using an applicator to have a thickness of 100 μm after drying, and subjected to a drying treatment at 130° C. for 15 minutes using a dryer, thereby obtaining an adhesive sheet of Example 2-1 including a film and a dried film provided on the film.

Subsequently, the PET film of the adhesive sheet was peeled off, a copper foil (trade name: 3EC-M2S-VLP, manufactured by Mitsui Mining & Smelting Corporation) was laminated on both surfaces of the dried film, and the obtained laminate was bonded using a vacuum laminator device under conditions of 75° C., 30 seconds, and −100 kPa to obtain a first laminate having a structure of copper foil/dried film/copper foil. The obtained first laminate was subjected to a curing treatment in a dryer at 200° C. for 1 hour. After curing, the copper foil was cooled to room temperature (25° C.), then removed by etching with an ammonium persulfate aqueous solution, and dried at 110° C. for 30 minutes to obtain a cured film of Examples 2-1.

### [Evaluation of Cured Film]

### <Measurement of Elastic Modulus>

A specimen having a sample size of 20 mm×10 mm was prepared using the cured film. Using this test piece, the elastic modulus at 20° C. was measured under the conditions of a frequency of 1 Hz, a measurement temperature of −40° C. to 220° C., and a temperature raising rate of 10° C./min with a dynamic viscoelasticity measuring device (trade name: DMS6100, manufactured by SII NanoTechnology Inc.). The results are shown in Table 2.

### <5% Weight Loss Temperature>

6.0 to 10.0 mg of the cured film was weighed in an open type sample container (trade name: P/N SSC000E030, manufactured by Seiko Instruments Inc.), measurement was performed under the conditions of a nitrogen flow rate of 300 mL/min and a heating rate of 10° C./min, and a 5% weight loss temperature (T_{d5}) was measured. As a measuring apparatus, TG/DTA7200 (manufactured by Hitachi High-Tech Science Corporation) was used. The results are shown in Table 2.

### <Evaluation of Dielectric Properties>

A specimen having a sample size of 50 mm×100 mm was prepared using the cured film. Using this test piece, a relative permittivity (Dk) and a dielectric loss tangent (Df) of 10 GHz were measured with a network analyzer (trade name: P5003A, manufactured by KEYSIGHT Technologies) and a split cylinder resonator (manufactured by KEYSIGHT Technologies, Inc.). From the measurement results, evaluation was performed based on the following criteria. When the evaluation result is A, it can be said that the dielectric properties are sufficiently excellent. The results are shown in Table 2.

### (Determination Criteria for Dk)

A: less than 2.5
B: 2.5 or more and less than 2.8
C: 2.8 or more

### (Determination Criteria for Df)

A: less than 0.0030
B: 0.0030 or more and less than 0.0050
C: 0.0050 or more

### <Measurement of Elongation at Break>

A specimen having a sample size of 50 mm×10 mm was prepared using the cured film. Using this test piece, both ends of the sample were fixed to shafts by 10 mm at a time on an autograph (trade name: AGS-X, manufactured by Shimadzu Corporation), and the elongation at break was measured under the condition of room temperature (25° C.) and a tensile speed of 10 mm/min. The results are shown in Table 2.

TABLE 2

| | | Exam. 2-1 |
|---|---|---|
| Component (A) | (A-1) | 55.1 |
| Component (B) | Pseudocumene | 44.9 |
| Component (C) | DCP | 0.55 |
| Evaluation item | Elastic modulus (GPa) | 0.3 |
| | T_{d5}(° C.) | 423 |
| | Relative permittivity Dk | A |
| | Dielectric loss tangent Df | A |
| | Elongation at break (%) | 190 |

As shown in Table 2, it has been confirmed that the resin composition of Example 2-1 can form a cured film (cured product) having excellent dielectric properties (low Dk and low Df) and a sufficient elongation at break.

### INDUSTRIAL APPLICABILITY

According to the present disclosure, there is provided a method for producing a resin composition capable of suppressing a side reaction in production of a polymaleimide resin. Further, the present disclosure provides a resin composition obtained by such a production method and a cured product thereof. By using the resin composition of the present disclosure, it can be expected to dramatically improve characteristics of an interlayer insulating material of a printed wiring board, a surface protective film of a semiconductor, an interlayer insulating film, an insulating film of a rewiring layer, and the like.

1. A method for producing a resin composition, the method comprising:
obtaining a polyimide resin by reacting a tetracarboxylic dianhydride with a polyamine in an organic solvent; and
obtaining a resin composition comprising a polymaleimide resin and the organic solvent by reacting the polyimide resin with maleic anhydride, wherein
the polyamine comprises dimer diamine, and
the organic solvent comprises 1,2,4-trimethylbenzene.

2. The method for producing a resin composition according to claim 1, wherein
the dimer diamine is at least one selected from a group consisting of a compound represented by general Formula (1) described below and a compound represented by general Formula (2) described below. 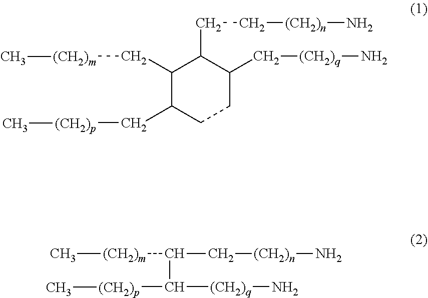
wherein, Formulae (1) and (2), m, n, p, and q each independently represent an integer of 1 or more. Here, m and n are integers satisfying a condition of m+n=6 to 17, and p and q are integers satisfying a condition of p+q=8 to 19. A bond indicated by a broken line represents a carbon-carbon single bond or a carbon-carbon double bond. However, when the bond indicated by the broken line is a carbon-carbon double bond, Formulae (1) and (2) have a structure in which the number of hydrogen atoms bonded to each carbon atom constituting the carbon-carbon double bond is subtracted by 1 from the numbers shown in Formulae (1) and (2).

3. The method for producing a resin composition according to claim 1, wherein
a blending amount of the dimer diamine is 20% by mol or more based on a total amount of the polyamine.

4. The method for producing a resin composition according to claim 1, wherein
a weight average molecular weight of the polymaleimide resin is 3,000 to 40,000.

5. A resin composition comprising:
a polymaleimide resin that is a reaction product of a tetracarboxylic dianhydride, a polyamine, and maleic anhydride; and
an organic solvent;
wherein
the polyamine comprises dimer diamine, and
the organic solvent comprises 1,2,4-trimethylbenzene.

6. The resin composition according to claim 5, further comprising a polymerization initiator is further contained,
wherein
the polymerization initiator comprises a thermal polymerization initiator or a photopolymerization initiator.

7. A cured product of the resin composition according to claim 5.

8. The method for producing a resin composition according to claim 2, wherein
a blending amount of the dimer diamine is 20% by mol or more based on a total amount of the polyamine.

9. The method for producing a resin composition according to claim 2, wherein
a weight average molecular weight of the polymaleimide resin is 3,000 to 40,000.

10. A cured product of the resin composition according to claim 6.

11. The method for producing a resin composition according to claim 1, wherein
an addition rate of the maleic anhydride when adding the maleic anhydride to the polyimide resin is 0.25 mol/min or more and 9.0 mol/min or less.

12. The method for producing a resin composition according to claim 2, wherein
an addition rate of the maleic anhydride when adding the maleic anhydride to the polyimide resin is 0.25 mol/min or more and 9.0 mol/min or less.

13. The method for producing a resin composition according to claim 1, wherein
an addition rate of the maleic anhydride when adding the maleic anhydride to the polyimide resin is 0.3 mol/min or more and 6.0 mol/min or less.

14. The method for producing a resin composition according to claim 2, wherein
an addition rate of the maleic anhydride when adding the maleic anhydride to the polyimide resin is 0.3 mol/min or more and 6 mol/min or less.
